(19) United States
(12) Patent Application Publication
(10) Pub. No.: US 2016/0061536 A1
(43) Pub. Date: Mar. 3, 2016

(54) Heat Exchanger and Method of Assembling the Same

(71) Applicant: Cerro Flow Products LLC, Sauget, IL (US)

(72) Inventors: Bradley Arment, Shelbyville, MO (US); Sean Patrick Kelleher, Manchester, MO (US); Matthew Lawrence Snyder, Carbondale, IL (US); Michael J. Duggan, St. Louis, MO (US); Harold A. Liller, Sauget, IL (US)

(21) Appl. No.: 14/833,487

(22) Filed: Aug. 24, 2015

Related U.S. Application Data
(60) Provisional application No. 62/041,958, filed on Aug. 26, 2014.

(51) Int. Cl. F28F 1/12; B23P 15/26

(52) U.S. Cl. CPC F28F 1/12; B23P 15/26

(57) ABSTRACT

A heat exchanger comprises a plurality of heat convection fins, first and second parallel U-shaped fluid tubes, and a fitting. Each of the first and second fluid tubes comprises a pair of leg portions and a U-turn portion that operatively connects the leg portions. The leg portions of the first fluid tube extend through at least some of the heat convection fins. The leg portions of the second fluid tube extend through at least some of the heat convection fins. The fitting comprises first and second female sockets. The first female socket is crimped to one of the leg portions of the first fluid tube. The second female socket is crimped to one of the leg portions of the second fluid tube. The fitting operatively connects the first and second fluid tubes.

### CROSS-REFERENCE TO RELATED APPLICATIONS

This application claims the benefit of provisional application Ser. No. 62/041,958, which was filed on Aug. 26, 2014, which is pending.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention pertains to a heat exchanger. More particularly, the present invention pertains to a heat exchanger having a pair of parallel U-shaped tubes and a crimp fitting fluidly connecting the pair of parallel U-shaped tubes.

2. General Background

As discussed in U.S. patent application Ser. No. 14/152,300, filed Jan. 10, 2014, (which is hereby incorporated into the present application by reference, in its entirety), crimp fittings can be used to join tubes together in a manner such that the joints are leak free at gauge pressures in excess of 2,000 psi (13.8 MPa). Thus, in addition to less demanding tube joints, such crimp fittings are well suited for use in connection with refrigeration lines.

### SUMMARY OF THE INVENTION

The present invention pertains to the use of crimp fittings to join U-shaped tubes of a heat exchanger together. The use of such crimp fittings eliminates joints that otherwise are typically brazed, thereby eliminating issues associated with using heat to join such U-shaped tubes.

In one aspect of the invention, a heat exchanger comprises a plurality of heat convection fins, first and second parallel U-shaped fluid tubes, and a fitting. Each of the first and second fluid tubes comprises a pair of leg portions and a U-turn portion that operatively connects the leg portions. The leg portions of the first fluid tube extend through at least some of the heat convection fins. The leg portions of the second fluid tube extend through at least some of the heat convection fins. The fitting comprises first and second female sockets. The first female socket is crimped to one of the leg portions of the first fluid tube. The second female socket is crimped to one of the leg portions of the second fluid tube. The fitting operatively connects the first and second fluid tubes.

Another aspect of the invention pertains to a method of assembling a heat exchanger. The method comprises assembling first and second fluid tubes to a plurality of heat convection fins. The first and second fluid tubes each comprise a pair of leg portions and a U-turn portion. The U-turn portion operatively connects the leg portions of the respective fluid tube. The assembling of the first and second fluid tubes to the plurality of heat convection fins occurs in a manner such that each of the leg portions of the first fluid tube extends through at least some of the heat convection fins and such that the leg portions of the second fluid tube extend through at least some of the heat convection fins. The method further comprises crimping a fitting to one of the leg portions of the first fluid tube. The fitting comprises first and second female sockets and the first female socket being crimped to one of the leg portions of the first fluid tube. The method further comprises crimping the second female socket to one of the leg portions of the second fluid tube in a manner operatively connecting the first and second fluid tubes to each other.

Further features and advantages of the present invention, as well as the operation of the invention, are described in detail below with reference to the accompanying drawings.

### BRIEF DESCRIPTION OF THE DRAWINGS

FIG. 1 is a front view of an embodiment of a heat exchanger in accordance with the present invention.

FIG. 2 is a perspective view of the embodiment of the heat exchanger shown in FIG. 1.

FIG. 3 is a front view of another embodiment of a heat exchanger in accordance with the present invention.

FIG. 4 is a perspective view of the embodiment of the heat exchanger shown in FIG. 2.

FIG. 5 is a side view of a heat convection fin.

FIG. 6 is a perspective view of the heat convection fin shown in FIG. 5.

FIG. 7 is a front view of a U-shaped fluid tube.

FIG. 8 is a perspective view of the U-shaped fluid tube shown in FIG. 7.

FIG. 9 is a perspective view of an embodiment of a crimp fitting, which is configured to join two equal diameter tubes coaxially to each other.

FIG. 10 is a top view of the fitting shown in FIG. 9.

FIG. 11 is a cross-sectional view of the fitting shown in FIGS. 9 and 10, taken along the line 11-11 shown in FIG. 10.

FIG. 12 is a detail view of FIG. 11.

FIG. 13 is a perspective view showing two fluid tubes inserted into the fitting shown in FIGS. 9-12.

FIG. 14 is a cross-sectional view of the assembly shown in FIG. 13.

FIG. 15 is a cross-sectional view depicting the assembly shown in FIGS. 13 and 14 after the fitting has been crimped to each of the fluid tubes.

Reference numerals in the written specification and in the drawing figures indicate corresponding items.

### DETAILED DESCRIPTION

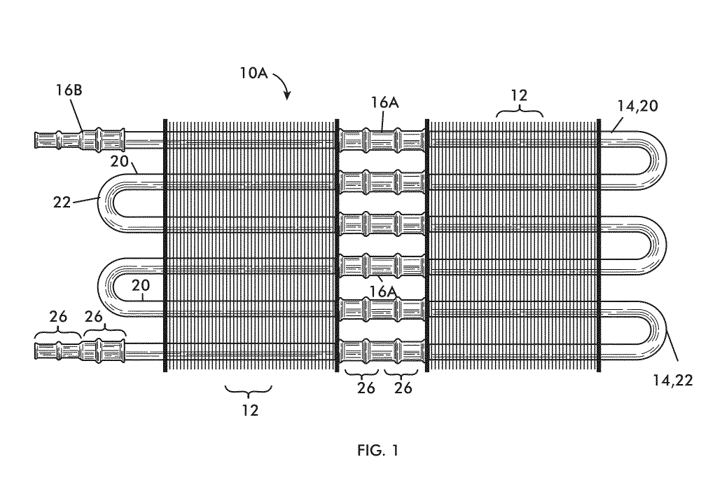

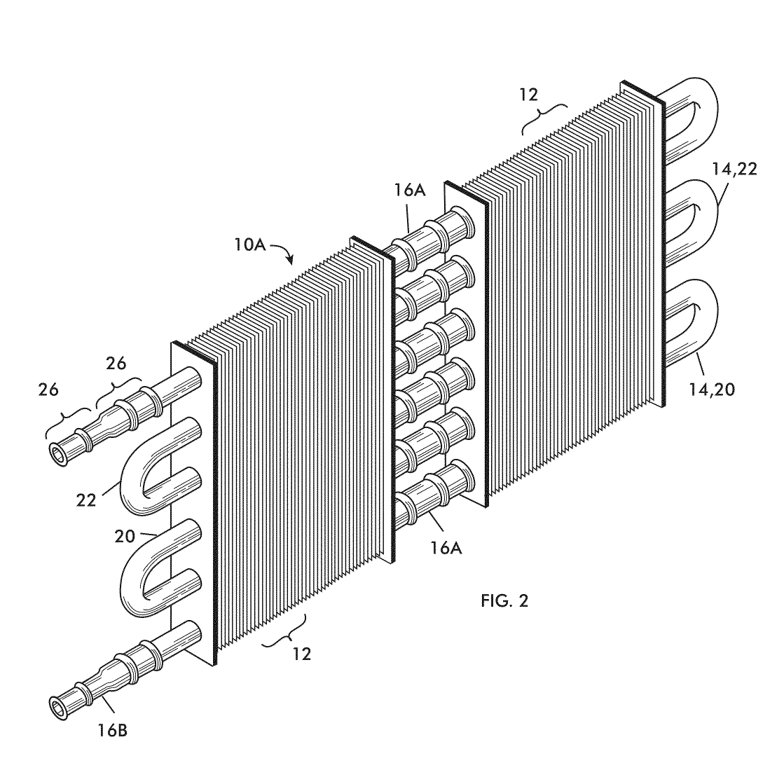

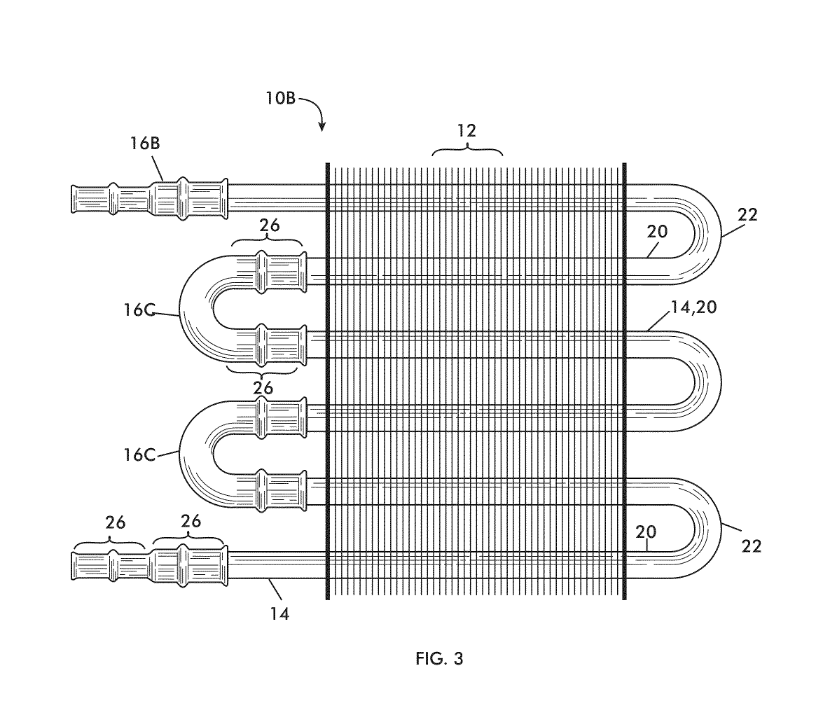

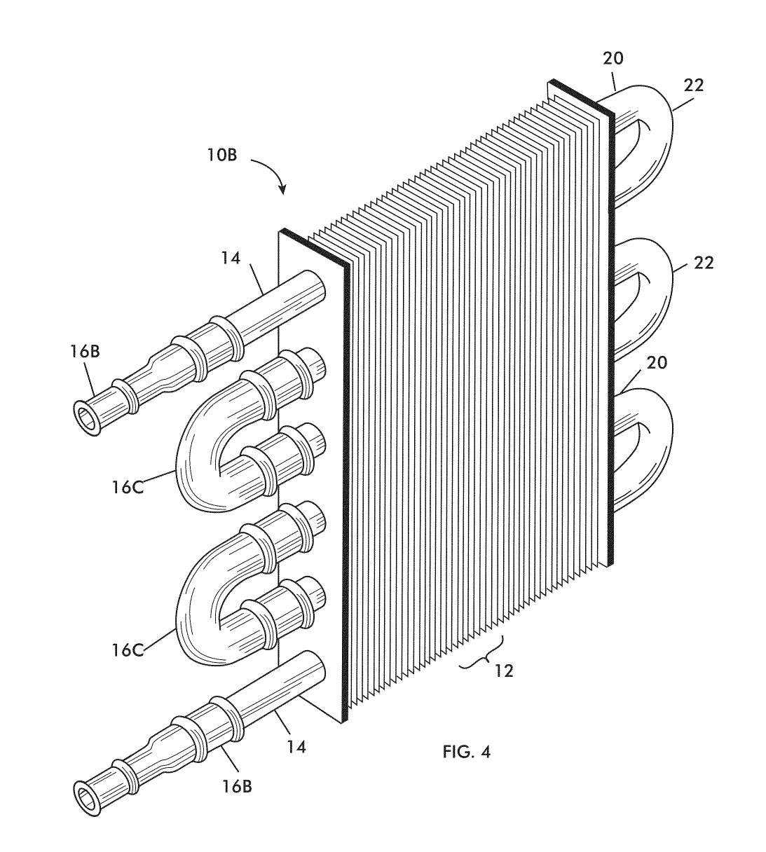

One embodiment of a heat exchanger (10A) in accordance with the invention is shown in FIGS. 1-2. In this embodiment, the heat exchanger (10A) comprises a plurality of heat convection fins (12), a plurality of U-shaped fluid tubes (14), and a plurality of fittings (16A, 16B). An alternative embodiment of a heat exchanger (10B) in accordance with the invention is shown in FIGS. 3-4. In this embodiment, the heat exchanger (10B) comprises a plurality of heat convection fins (12), a plurality of U-shaped fluid tubes (14), and a plurality of fittings (16B, 16C).

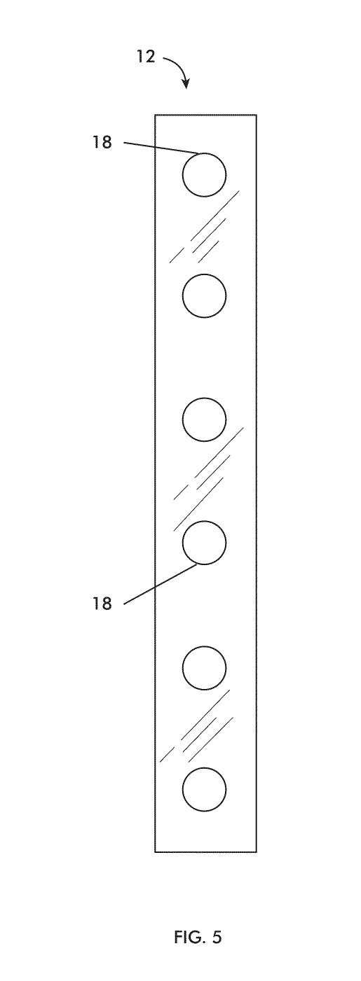

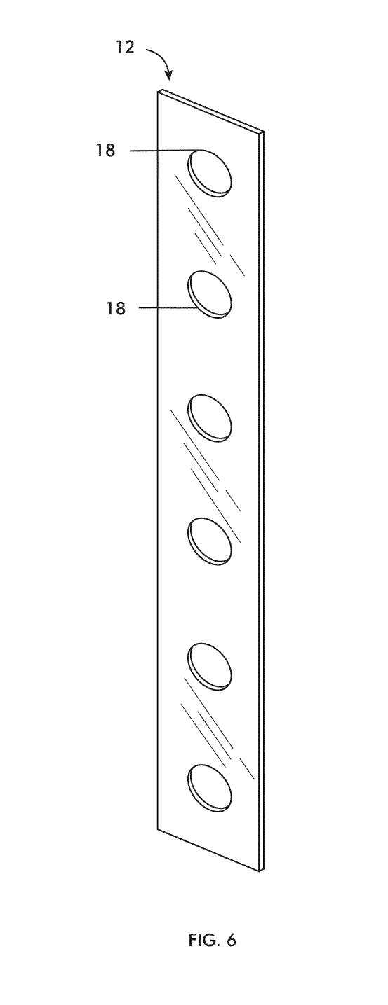

As shown in FIGS. 5-6, each heat convection fin (12) has a plurality of holes (18). Each hole is configured and adapted to receive therethrough a leg portion (20) of one of the U-shaped fluid tubes (14). The diameter of each hole is preferably approximately equal to the diameter of the leg portion (20) inserted therethrough such that the heat convection fin (12) fits securely around the circumference of said leg portion and/or can be brazed to the leg portion (20) of the U-shaped fluid tube.

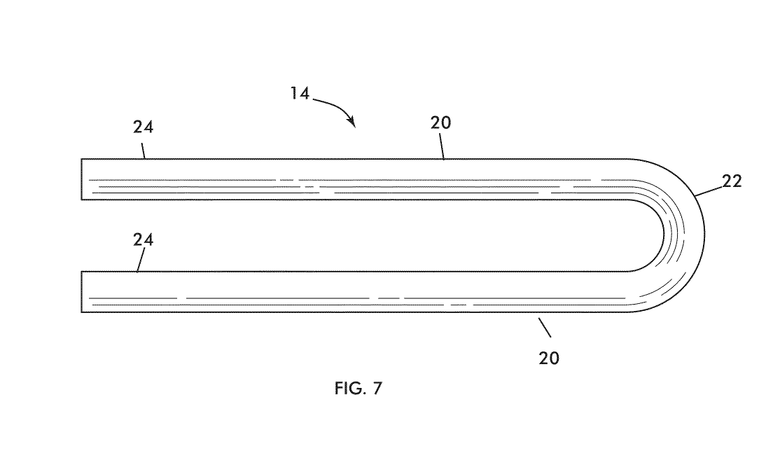

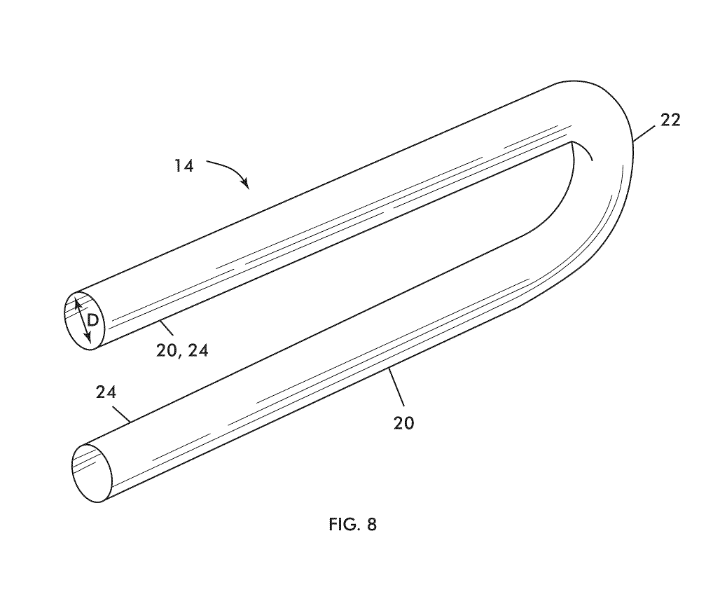

FIGS. 7-8 show one of the U-shaped fluid tubes (14). Each fluid tube comprises first and second leg portions (20) and a U-turn portion (22). Each leg portion (20) is operatively connected to the other leg by the U-turn portion (22). Preferably the U-shape fluid tube is formed merely by bending a straight section of tubing into the U-shape using conventional techniques. Each leg (20) has a terminal end (24) opposite the U-turn portion (22). The terminal end (24) of each leg (20) has a diameter (D).

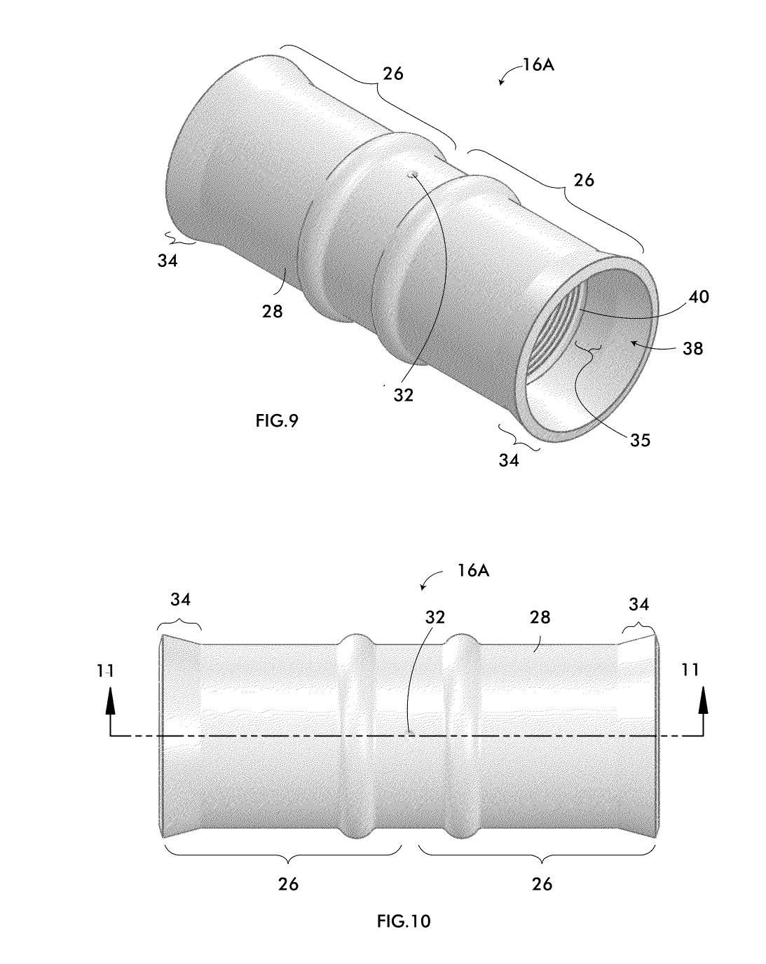

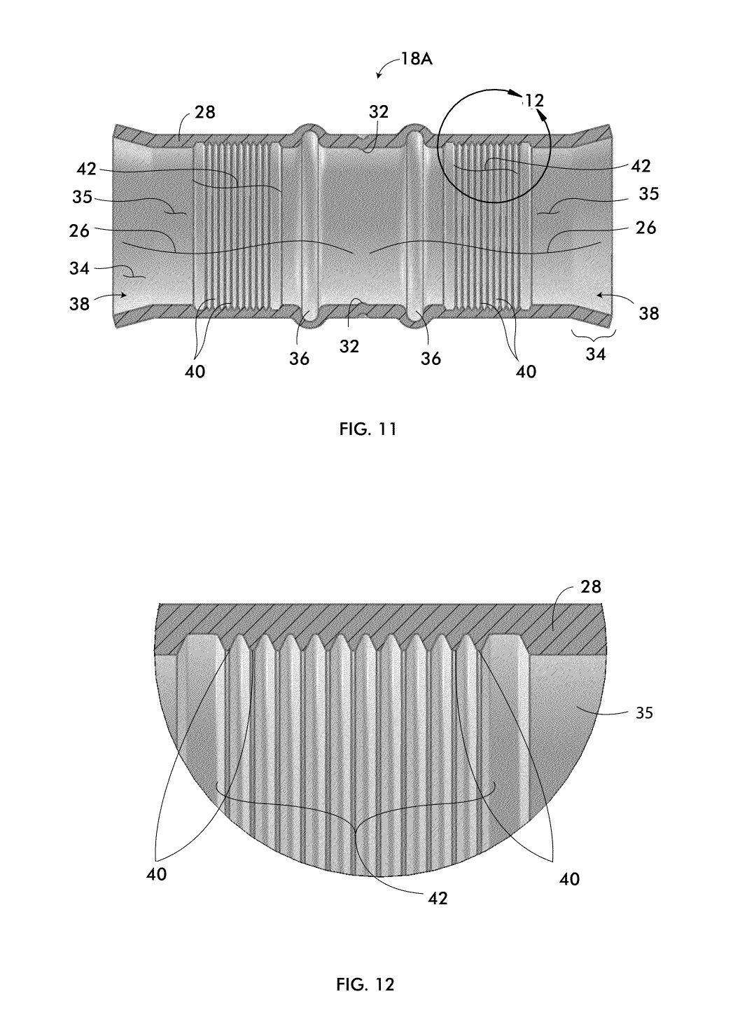

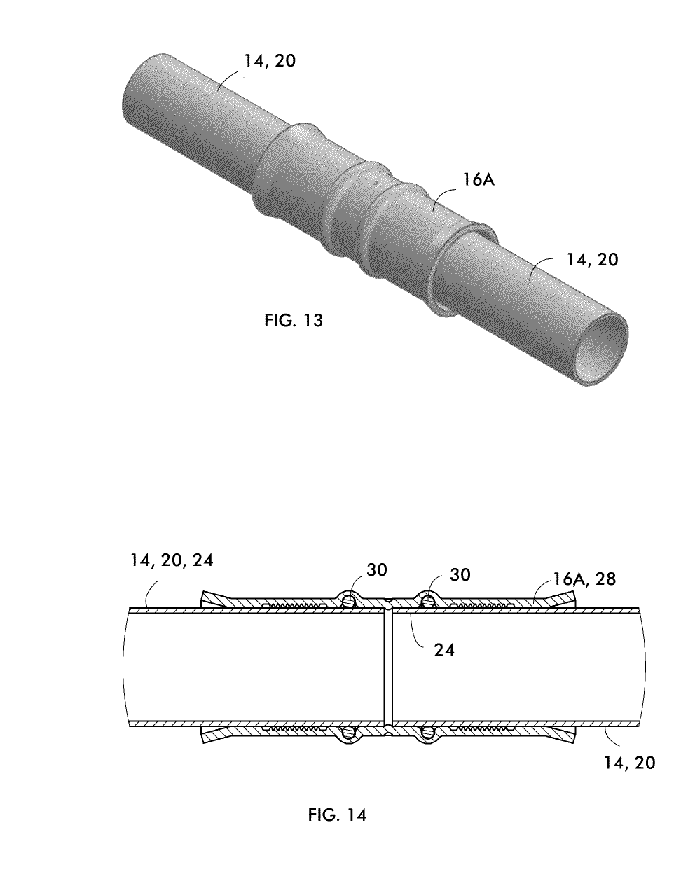

The fittings (16) may have a number of different configurations. The straight fitting (16A), shown in FIGS. 1, 2, and 9-15, is configured to join two equal diameter tubes coaxially to each other. The reduction fitting (16B) shown in FIGS. 1-4 is preferably substantially straight and is configured to coaxially join two tubes of differing diameters. The U-shaped fitting (16C) shown in FIGS. 3 and 4 is a U-shaped fitting and is preferably configured to join two equal diameter and parallel tubes to each other. It should be appreciated that there are other possible fitting configurations. Regardless of its shape or configuration, each crimp fitting (16) comprises first and second female sockets (26). Each fitting (16) is primarily formed by a single monolithic annular wall (28), but may also comprise one or more O-rings (30). The annular wall (28) is preferably formed of metal such as copper or aluminum alloy. The O-rings (30) may be brazing rings (30) configured to melt when the fitting is subjected to fire, or may be elastomeric O-rings made of a material which can withstand temperatures up to 1000° F. (538° C.) without losing elasticity. The annular wall (28) of the fitting (16) forms the first female and second female sockets (26). The annular wall (28) is preferably formed by deforming a straight section of metal tubing. A dimple insertion stop (32) may be press-formed into the top and bottom of the annular wall (28) of the fitting (16). Each of the first and second female sockets (26) preferably comprises a flare (34) and an O-ring channel (36) formed into the annular wall (28) of the fitting (16). The flare (34) extends from a generally cylindrical portion (35) of the respective socket (26) and flares radially outward as it extends to an axial opening (38) of said socket. The O-ring channel (36) and the flare (34) are preferably formed using a hydroforming technique. One or more annular sealing protrusions (40) are formed on the inner surface of the annular wall (28), preferably between the O-ring channel (36) and the cylindrical portion (35) of each socket (26). The annular sealing protrusions (40) are preferably formed by cutting grooves into portions of the annular wall (28) between the sealing protrusions, and preferably each socket (26) comprises a series of such sealing protrusions that form an axially serrated portion (42) within each socket. The grooves may be semi-circular, V-shaped, or square, or any other shape desired. Additionally, rather than forming a series of sealing protrusions (40) that are transverse to the center axis of the fitting (16), the axially serrated portion (42) within each socket (26) could be formed by cutting a helical groove into the annular wall (28) (thereby forming a helical sealing protrusion). The depth of the grooves is preferably in the range of 0.010 and 0.015 inches (approximately 0.25 to 0.38 mm). The annular wall (28) of the fitting (16) is preferably annealed to a soft temper with a grain size between 0.005 mm and 0.070 mm.

The heat exchanger is preferably assembled by first inserting the leg portions (20) of each of the fluid tubes (14) through the holes (18) of at least some of the plurality of heat convection fins (12). In the heat exchanger (10b) shown in FIGS. 3 and 4, the U-shaped fluid tubes (14) all extend to the same set of heat convection fins (12). In the heat exchanger shown in FIGS. 1 and 2, each pair of U-shaped fluid tubes (14) that are to be connected to the same crimp fitting (16) do not extend through any of the same heat convection fins (12). Preferably, all of the fluid tubes (14) are attached to heat convection fins (12) in that manner prior to attaching any of the crimp fittings (16) to the assembly. Additionally, to the extent the assembly involves any brazing (e.g., brazing of the convection fins to the fluid tubes), the brazing preferably also occurs prior to attaching any of the crimp fittings (16) to the assembly. It should be appreciated that prior to attaching the crimp fittings (16), the heat exchanger (10B) shown in FIGS. 3 and 4 is identical to either side of the heat exchanger (10A) shown in FIGS. 1 and 2. Thus, an assembly comprising heat convection fins (12) and U-shaped fluid tubes (14) can be used to create either configuration of a heat exchanger, with two being used to create the heat exchanger embodiment shown in FIGS. 1 and 2.

Following the foregoing steps, the U-shaped fluid tubes (14) are then operatively connected to each other via the crimp fittings (16). This is done by inserting each terminal end (24) of each leg portion (20) of the fluid tubes (14) into a respective one the female sockets (26) of the crimp fittings (16) and thereafter crimping the female sockets. Preferably two of the crimp fittings (16C) are reduction fittings that are configured to connect the heat exchanger (10) to external supply and return lines that are smaller in diameter than the U-shaped fluid tubes (14). As is noticeable in FIG. 12, each of the annular sealing protrusions (40) of the serrated portion (42) of each socket (26) of the crimp fittings (16) has an innermost diameter that is slightly greater than the adjacent cylindrical portion (35) of the socket. This ensures that as the portion of the terminal end (24) of a leg portion (20) of a U-shaped fluid tube (14) is inserted into the socket (26), said portion of the terminal end does not contact the sealing protrusions (40). Of course, that is because the cylindrical portion (35) has a diameter that fits snugly around the portion of the terminal end (24) of the fluid tube (14). As such, the sealing protrusions (40) cannot be damaged merely by inserting the terminal end (24) of a fluid tube (14) into the socket (26). Prior to inserting the portion of the terminal end (24) into one of the female sockets (26), the grooves between the sealing protrusions (40) of that socket are preferably filled with a high temperature sealant (not shown), such as Superior Seal & Assist #5000 produced by Superior Industries. Shortly thereafter, the portion of the terminal end (24) of the fluid tube (14) is inserted into the female socket (26). Upon contacting the dimple insertion stops (32) of the fitting (16), the leg (20) is fully inserted into the fitting (16) and the female socket (26) can then be crimped.

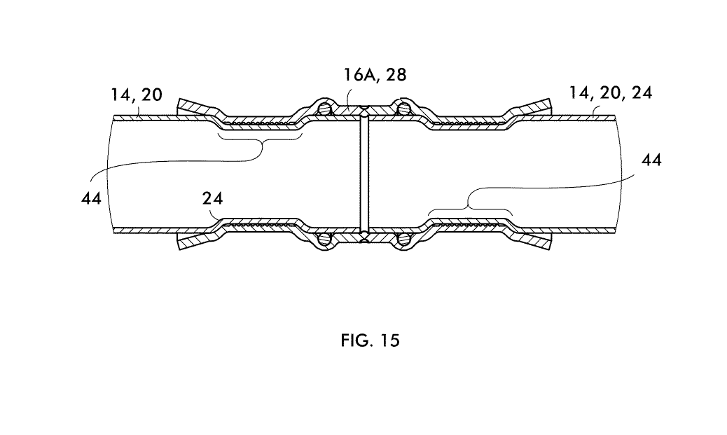

The crimping process is preferably performed in a generally uniform manner, as is described in U.S. patent application Ser. No. 13/714,002. The radially outward extending bulge created by the formation of the brazing ring channel (36) and the flare (34) of each of the female sockets (26) preferably serve as guides between which the crimper straddles the fitting (16) during the crimping process. This ensures that the crimper is axially located in the most ideal location along each of the female sockets (26). Preferably the crimper only crimps the annular wall (28) in the region of the sealing protrusion (40) or serrated portion (42) of the female socket (26). As this occurs, the soft (annealed) sealing protrusion(s) (40) radially conforms against the portion of the terminal end (24) of the respective leg and a corresponding portion (44) of said portion of the terminal end (24) necks-in as shown in FIG. 15. Simultaneously, the crimping also causes the sealant to flow out of the grooves between the sealing protrusions (40) and into the spaces radially between the sealing protrusions and the portion of the terminal end (24). The crimping also causes the crimped portion of the annular wall (28) to work harden. Because the fitting (16) is initially annealed and work hardens during the crimping process and the portion of the terminal end (24) is fully hard, after crimping, the necked-in portion (44) of said portion of the terminal end will remain radially biased against the sealing protrusion(s) (40) with a radial compression force that creates a pressure seal sufficient to withstand a pressure differential in excess of 300 psi (2.07 MPa). It should also be appreciated that the crimping creates interlocking geometry between the fitting (16) and the portion of the terminal end (24) that prevents said portion of the terminal end (24) from thereafter pulling axially out of the fitting. Still further, it should be appreciated that the sealant is configured to remain liquid or pliable when at high temperatures in a manner such that the sealant will not crack should the fitting axially expand in a fire. Thus, the sealant provides additional sealing capability in the event of fire.

As mentioned above, an O-ring (30) can also be positioned in the respective O-ring channel (36) prior to inserting the portion of the terminal end (24) of one of the legs into the respective female socket (26) of the fitting (16). If the O-ring (30) is a brazing ring, its purpose is not to be brazed when forming the joint between the fitting (16) and the portion of the terminal end (24). Instead, the brazing ring (30) acts as a backup sealing means in the event the joint is subjected to fire or other abnormally high temperatures. When the joint is subjected to such fire or other abnormally high temperatures, the brazing ring (30) will melt and form an additional barrier to gas leaks. Alternatively, the O-rings (30) may be high temperature elastomeric O-rings as mentioned above. If such elastomeric O-rings are used, a crimping tool may be configured to apply lesser compressive forces onto exterior portions of the annular wall (28) that encircle the O-ring channels (36) during the process of crimping the fitting (16). Doing so would increase the compression of the O-rings and improve the effectiveness of the O-rings. In either case, the purpose of any O-rings (30) would be to provide backup sealing means in the event the joint is subjected to fire or other abnormally high temperatures. In either case, the crimping process is preferably performed in a generally uniform manner, as is described in U.S. patent application Ser. No. 13/714,002.

In view of the foregoing, it should be appreciated that the invention achieves several advantages over prior art heat exchangers.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed.

What is claimed is:

1. A heat exchanger comprising:
a plurality of heat convection fins, each of the heat convection fins;
first and second U-shaped fluid tubes, each of the first and second fluid tubes comprising a pair of leg portions and a U-turn portion that operatively connects the leg portions, the leg portions of the first fluid tube extending through at least some of the heat convection fins, the leg portions of the second fluid tube extending through at least some of the heat convection fins;
a fitting comprising first and second female sockets, the first female socket being crimped to one of the leg portions of the first fluid tube, the second female socket being crimped to one of the leg portions of the second fluid tube, the fitting operatively connecting the first and second fluid tubes.

2. A heat exchanger in accordance with claim 1 wherein the fitting is U-shaped.

3. A heat exchanger in accordance with claim 1 wherein the leg portions of the first fluid tube extend through the same heat convection fins as do the leg portions of the second fluid tube.

4. A heat exchanger in accordance with claim 3 wherein the fitting is U-shaped.

5. A heat exchanger in accordance with claim 1 wherein the first female socket is similar in size to the second female socket.

6. A heat exchanger in accordance with claim 5 wherein the fitting constitutes a first fitting and the heat exchanger further comprises a second fitting, the second fitting is a reduction fitting and has a larger end and a smaller end, the larger end is crimped to the other one of the leg portions of the first fluid tube, and the smaller end is configured and adapted to be crimped to a fluid supply tube that is external to the heat exchanger.

7. A heat exchanger in accordance with claim 1 wherein each of the first and second female sockets of the fitting comprises an O-ring.

8. A heat exchanger in accordance with claim 1 wherein the leg portions of the first fluid tube and the leg portions of the second fluid tube are all parallel to each other.

9. A method of assembling a heat exchanger comprising:
assembling first and second fluid tubes to a plurality of heat convection fins, the first and second fluid tubes each comprising a pair of leg portions and a U-turn portion, the U-turn portion operatively connecting the leg portions of the respective fluid tube, the assembling of the first and second fluid tubes to the plurality of heat convection fins occurring in a manner such that each of the leg portions of the first fluid tube extends through at least some of the heat convection fins and such that the leg portions of the second fluid tube extend through at least some of the heat convection fins;
crimping a fitting to one of the leg portions of the first fluid tube, the fitting comprising first and second female sockets, the first female socket being crimped to the one of the leg portions of the first fluid tube;
crimping the second female socket to one of the leg portions of the second fluid tube in a manner operatively connecting the first and second fluid tubes to each other.

10. A method in accordance with claim 9 wherein the fitting is U-shaped.

11. A method in accordance with claim 9 wherein the leg portions of the first fluid tube and the leg portions of the second fluid tube are assembled to the heat convection fins in a manner such that they all extend through the same heat convection fins.

12. A method in accordance with claim 11 wherein the fitting is U-shaped.

13. A method in accordance with claim 9 wherein the first female socket is similar in size to the second female socket.

14. A method in accordance with claim 13 wherein the fitting constitutes a first fitting and the method comprises crimping a second fitting to the other one of the leg portions of the first fluid tube, the second fitting is a reduction fitting and has a larger end and a smaller end, and the larger end is crimped to the other one of the leg portions of the first fluid tube.

15. A method in accordance with claim 9 wherein the leg portions of the first fluid tube and the leg portions of the second fluid tube are all parallel to each other after completing the method.
